(19) United States
(12) Patent Application Publication
(10) Pub. No.: US 2008/0177635 A1
(43) Pub. Date: Jul. 24, 2008

(54) Method, system, and apparatus for suggesting or requesting a proxy transaction

(76) Inventor: David Brian Handel, Galloway, NJ (US)

Correspondence Address: MAXVALUEIP CONSULTING, 11204 ALBERMYRTLE ROAD, POTOMAC, MD, 20854, US

(21) Appl. No.: 11/626,275

(22) Filed: Jan. 23, 2007

(51) Int. Cl. G06Q 20/00; G06Q 30/00; G06Q 99/00

(52) U.S. Cl. 705/26; 705/39; 705/1

(57) ABSTRACT

“Buy This for Me” (BTFM) is a business model, where shoppers/users can go shopping on-line, and upon checkout, seek the assistance of a friend (typically, someone they know, and whose email address or other contact information they know, such as physical address, SMS/cell, etc.), for the purpose of paying for all or some of the payment for some or all of the items in their shopping cart(s), from one or more stores, under the management of another entity (called OW). This encourages more gifts and more e-commerce. Different variations and methods are discussed for this purpose and model.

### BACKGROUND

The gift-registry or gift-giving is a big industry. Here, we have described a novel method/system for this industry/purpose. Some related prior art are:
http://commissionjunction.com/
   http://webservices.cj.com/
   http://www.ourbigshop.com/
   http://exit39.com/
   These deal with commission, affiliate marketing, measuring metrics (e.g. income/click), targeted product ads, shopping, and web services.
https://www.paypal.com/IntegrationCenter/ic_pdnHome.html
   https://www.paypal.com/IntegrationCenter/ic_home.html
   https://www.paypal.com/IntegrationCenter/ic_api-reference.html
   These deal with PayPal model, API-reference, and e-commerce business/service.
http://www.amazon.com/gp/browse.html/ref=sc_fe_{—}1_{—}2/103-1644811-9832630?%5Fencoding=UTF8&node=12738641&no=3435361
   http://www.programmableweb.com/api/Amazon
   http://solutions.amazonwebservices.com/connect/kbcategory.jspa?categor yID=63
   Familyholidaywishlist.com
   These deal with Amazon business model, API, wish-list, and web services.
http://www.your-wishlist.com/about.php
FamilyHolidayWishLists.com
http://solutions.amazonwebservices.com/connect/entry.jspa?externalID=503&cate goryID=63
http://www.textbox1.com/apps/AmzWish/
These deal with wish-list and web services.
   These are some related issued US patents, with their corresponding titles:
U.S. Pat. No. 7,039,601, Method and system for monetary gift registry,
U.S. Pat. No. 6,968,057, Emulsion products and imagery employing steganography,
U.S. Pat. No. 6,618,753, Systems and methods for registering gift registries and for purchasing gifts,
U.S. Pat. No. 6,609,106, System and method for providing electronic multi-merchant gift registry services over a distributed network,
U.S. Pat. No. 6,493,742, System and method for providing internet accessible registries,
U.S. Pat. No. 5,970,474, Registry information system for shoppers,
U.S. Pat. No. 5,898,594, Method and apparatus for enabling a selection of catalog items,
U.S. Pat. No. 5,754,981, Gift registry apparatus and method, (such as wedding or birthday registry)
However, none of them is teaching the features of the current invention.

### SUMMARY

One of the embodiments deals with the concept of “Buy-This-for-Me: request for e-commerce or purchase.” A person (or a combination of one or more people or entities, called “user(s)”, for convenience) is empowered to shop, and instead of concluding the check-out, the user can click a “buy-this-for-me” button, which will forward a request to someone of user's choosing (or to multiple people, called “Friend(s)”, for convenience, but generally, it can be anybody or any entity.) to review the shopping cart contents, and if the friend(s) desire, the friend(s) would buy the items/services/objects for the requesting person (user). This also applies to future purchases, licensing, renting, stocks, contracts, installments, or subscriptions, with both partial and full payment.

In one of the embodiments, the request is sent with an e-card to entice the person being requested. The request can go in multiple steps to the next persons (a friend of the friend), as in pyramid/hierarchical structure, based on the condition or permission by the original requesting person (user) and/or the person originally being requested (first friend).

In one of the embodiments, the service is offered from a server of a company (e.g. called OurWebSite, or “OW”) that allows merchants (“Store(s)”) to paste code into their sites, and the OW server mediates and manages the “buy this for me” (“Would you consider buying this for me?”) transactions.

In one of the embodiments, a button allows a person/user to fill out a request and contact information, such as e-mail address, SMS, cell number, etc, of a friend, so that the e-commerce merchant/store can then reach out to the friend (being requested to be the payer). If that friend agrees, the friend then supplies a credit card number (or by other means, such as PayPal or cash), and the purchase for the user is completed. The delivery of the merchandise or service can be directly to the user, or through the friend.

In one of the embodiments, the shopper/user is able to save the first cart for his/her first friend to pay, re-enter the store, do more shopping, create another shopping cart that is unrelated to the saved first cart, check out with the second cart, pay for them (using the user's own funds, or sending the second request to another/second friend).

Thus, in general, the user may have multiple carts from multiple stores, dealing with multiple OWs and multiple friends, with one or more carts correspond to one or more friends or stores. One can put multiple carts in another “jumbo-cart”, to aggregate multiple friends, OWs, or stores, for ease of management or ease of payment tracking/accounting.

In one of the embodiments, the first user can be a proxy or guardian for another (2^{nd}) user, making the selection (or mere suggestion, requiring/pending approval of the second user) of the items in the cart, instead of the 2nd user. This can be done based on the voting mechanism (with or without veto feature). This can be done based on the prior authorization, by specific persons or entities, based on some legal relationship, enforced by contracts and/or PKI encryption/signature schemes.

### BRIEF DESCRIPTION OF THE DRAWINGS

FIG. 1 describes an initial phase of the system/procedure, to set up initial account for the user.

FIG. 2 describes the next phase of the system/procedure, after the friend and the store are also involved in the process.

### DETAILED DESCRIPTION OF THE PREFERRED EMBODIMENTS

In one of the embodiments, “Buy This for Me” (BTFM) is a business model, where shoppers/users can go shopping on-line (or in combination of off-line transactions/bricks and mortar stores), and upon checkout, seek the assistance of a friend (typically, someone they know, and whose email address or other contact information they know, such as physical address, SMS/cell, etc.), for the purpose of paying for all or some of the payment for some or all of the items in their shopping cart(s).

In one of the embodiments, this involves the shopper/user placing items in the shopping cart, going to checkout, filling out their shipping information, clicking the BTFM button, and then being presented with a page where they can optionally select, customize, and send through the website or e-card (or other electronic or physical mail or message) to the proposed friend, for the purpose of requesting them to agree to pay for a part or all of the purchase (and/or shipping) price or fee. If the friend agrees, there are various well-known methods by which they might be facilitated in supplying their credit card or other digital payment information to cover the purchase. The business model can be monetized by various methods, including commissions for BTFM sales, or sale, license, or lease of the software and platform/system.

In one of the embodiments, it involves the following features:
OW can simply manage the transaction and get a commission on the backend with the cash first flowing to the e-commerce site.
OW can process the transaction, pay the credit card fees, keep its commission, and pass the balance to the e-commerce site, but it also accepts the risk of being liable for the e-commerce charge-backs.
OW can license other e-commerce sites to set up and manage their own “buy this for me” program, possibly providing them with the code/license to do this.
   The license could be at certain rate per unit time
   It could be a sale of a non-exclusive license
   It could be a license that provides software that has a “meter” that calculates commissions and notifies OW, so that the invoices can be issued. In this model, the e-commerce site hosts the code on their own server, processes their own sales, and generates commission information for themselves and OW.
* OW web site registers the friends with accounts at OW, or just at the e-commerce sites (or both).
People can come to the OW web site (on a primary basis), register, and go shop at participating merchants featured at the OW web site.

This “primary basis” approach is used to get an affiliate fee, if the user then goes from OW web site to (and shops at) a participating e-commerce site (but doesn't use the “buy this for me” button). If they do go through OW web site to a participating site to shop, and then also use the BTFM button, then OW should get both an affiliate fee and a BTFM button commission fee (or a combination of those fees).

In one of the embodiments, it involves the following features:
1. a site which has an online portal to the shopping experience.
2. where a kid can go to any e-commerce site, browse, and place items in a shopping cart, even though they don't have a registered account at that site.
3. where, in desiring to purchase the cart's contents, the kid can click on a button, so that the shopping cart and its contents get uploaded to the OW server, and OW will notify their parents by e-mail, SMS, and a host of other possible ways, that there is a filled shopping cart that their kid is asking for them to examine, approve, financially authorize, and/or purchase (directly or indirectly).
4. where the parents can respond to the e-mail (and login to their private half of the joint OW account), and see the shopping cart contents.
5. where the shopping cart contents can be sent by the kid to the parent(s) in the form of an e-card, that lets the kid choose the artwork, message, express their feelings towards the parent, or make certain commitments/promises, such as “I will study 2 hours a night for the next 2 weeks.”
6. where the parent can respond back to the kid unemotionally as to why the answer to the request is “yes” or “no.”
7. where the parents, if the answer is yes, can (with a click) take the shopping cart to check out (and then register themselves at the e-commerce site, if needed), and complete the purchase transaction.
8. where OW gets an affiliate commission for hosting/facilitating the purchase.
9. where OW keeps a record of the requests, e-cards, the kid's various commitments to the parent, etc, so that the next time the kid asks for something, the parent can look at the past promises and performance, and use that to make future buying decisions, or negotiate future commitments from their kid.
10. where the parent sees OW as a part of a CRM (child relationship management system), and the kid sees it as a part of a PRM (parent relationship management system).
11. where both parents and kids see OW as a tool for communication, expressing love, establishing boundaries, and commitments
12. where kids can now legally shop with their parents' consent.
13. where the OW portal might get ad revenues from stores, besides the affiliate commissions.
14. where the shopping portal can host reviews of stores, products, and services, with separate kids' ratings and parents' ratings/scoring.

In one of the embodiments, it involves the following features: User can choose and customize a card. The friend can accept or deny the transaction, with or without a note or explanation, directly to the user or through OW, partially or fully, with or without a counteroffer for the percentage of transaction or part of the shopping cart(s). The commissions from transactions can be aggregated per month or week, and paid to OW in one transaction.

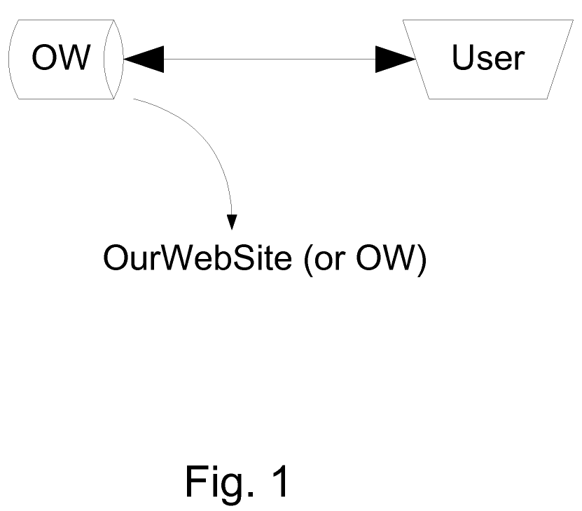

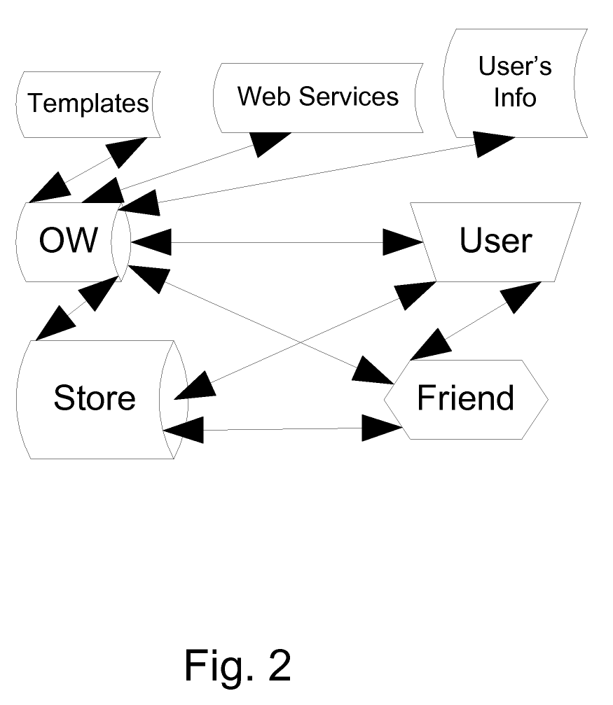

Now, let's look at another embodiment, described in FIGS. 1-2. FIG. 1 describes an initial phase of the system/procedure, and FIG. 2 describes the next phase of the system/procedure.

In FIG. 1, the user registers with the OW, setting up an account, and obtains information/data about/for shopping basket/cart and various plug-ins for the future operation of the system/user. Note that the items selected can come from one or more OWs and stores. User can also enter the information automatically, manually, or semi-manually.

In FIG. 2, the user goes to an on-line store, to browse and select/put items in the cart. The store can supply an API (application programming interface) or XML, along with the purchasing data, item numbers, etc., on a specific format for files, headings, and data, beforehand, as a partner with the OW organization, on a specific contract/agreement, or just based on a general offering/relationship with the OW, e.g. when the store discloses its interface and its requirement to the public, so that others (including OW) would be able to write an interface to communicate with the store.

For example, the store can have a web service offering, which OW can hook into. Alternatively, the information regarding page content, the selected object, and the URL can be sent directly. Alternatively, the templates for interface/web content for the most-used/common/famous/popular stores can be generated and stored in the OW databases, in advance, for interfacing with those stores, if or when the user approaches OW with such a pending transaction, in order to facilitate and speed up such transactions with the most popular stores on the Internet.

The user can contact OW, to provide personal information about himself/herself (user) and the information about the friend(s), e.g. e-mail or cell phone number (optional).

The password and security modules are also part of the offering with the OW organization/web site, including biometrics or smart cards. OW has various databases or storages for User's information, Friend's information, web services, templates, and account information. OW can also temporarily store the information about the most common items/stores/web sites, for faster access and processing, for the repeat users or the repeat requests for the same items or stores.

The cart and account information are exchanged between the user and OW. The information about the item or store are expressed based on URL, manually selecting content on the screen by selecting an area of the screen by the user (filtering) (or visually selecting the item on the screen) (portal editing technology) (capturing items either visually on screen, or using corresponding tags/web page description), meta-data tags, template for web site for existing data, web services offered by the store, or similar techniques.

The friend gets a notice or message (by any analog or digital means, e-mail, regular mail, cell phone message, text message, etc.) from User or OW. The information about the user ID and cart/content ID/information (e.g. item ID from the store), along with plug-ins needed for the friend, are given to the friend (by the user, OW, or both of them). Other information given to the friend includes: simple web page information with the list of URL, or more organized information which also includes purchasing information.

The friend can go to the OW site for more information and updates on old information. The friend can also go to store site. Using the plug-ins, the friend can access the items in the cart (with description and web site information), review them, select them (e.g. using a click, or visually selecting the item), and buy them for the user. Note that the plug-ins (e.g. for browser, or specific function or task mentioned above, sometimes having the capability to run a code, as well) can be used to do the process automatically, manually, or semi-manually. After the purchase, the number of units sold, along with any other marketing information and statistical data, are transferred back to the user and/or OW, for aggregation and analysis/data mining, if desired. The transaction information is either collected automatically by plug-ins, or asked directly from the user (collected manually).

Alternatively, the friend can buy the item from a regular physical store (a non-Internet store), and fills up the needed transaction information directly himself, or using plug-ins for recording and transfer of the information to the user or OW.

In one of the embodiments, the user browses for goods and services directly at the OW web site. These goods and services are sourced from other ecommerce web sites by their APIs, or are sourced from affiliate management networks such as http://commssionjunction.com/ via the use of their APIs. The user then selects items from the inventory shown at the OW web site, puts them in a shopping cart, and clicks a “buy this for me” button, as described in the other embodiments. In addition, the goods and services can come from other stores, such as Amazon.com, through their APIs.

Furthermore, in another embodiment, the payment can also come from Visa or PayPal, or the whole system described in this invention can be run from Visa or PayPal website, or alternatively, incorporated or combined with their systems, so that their customers can access the OW through PayPal or Visa, or alternatively, PayPal and Visa have their own version of OW inside their systems, by licensing it from OW organization.

The system can use one or more of the following to notify: e-mail, regular mail, SMS, cell phone, regular phone, instant messaging, text messaging, or any digital or analog methods.

Any other variations of the teachings above are also intended to be covered and protected by the current patent application.

1. A system for requesting or suggesting a proxy transaction, said system comprising:
a central place; and
an inventory,
wherein a user accesses said central place to register with said central place,
wherein said user accesses said inventory to select one or more items, objects, or services,
wherein said user suggests or requests to a second entity to pay for all or part of said selected one or more items, objects, or services, and
wherein if said second entity accepts said suggestion or request to pay, then said second entity pays for all or part of said selected one or more items, objects, or services.

2. A system as recited in claim 1, wherein said second entity is a friend, parent, family member, friend of a friend, colleague, guardian, legal entity, corporation, employer, supervisor, birthday guest, wedding guest, or guest.

3. A system as recited in claim 1, wherein said system applies one or more of the following: affiliate marketing, ad-based revenue, or commission.

4. A system as recited in claim 1, wherein said system uses one or more of the following to set up the interface: API, XML, template, web service, URL, or visually-selected objects on screen.

5. A system as recited in claim 1, wherein said system uses one or more of the following: wish-list or gift-registry.

6. A system as recited in claim 1, wherein said system uses one or more plug-ins to gather, transfer, or manipulate data or information.

7. A system as recited in claim 1, wherein said system uses a hierarchical model within said second entity.

8. A system as recited in claim 1, wherein said system uses one or more of the following to notify: e-mail, regular mail, SMS, cell phone, regular phone, instant messaging, text messaging, or any digital or analog methods.

9. A system as recited in claim 1, wherein said system uses one or more of the following for payment: credit card, cash, check, PayPal, money order, cashier's check, wire transfer, store credit, digital cash, valuable metal or stone, or other tangible or intangible objects or items.

10. A system as recited in claim 1, wherein said system uses one or more shopping carts or baskets, one or more inventories, one or more central places, or one or more web sites on Internet or a computer network.

11. A system as recited in claim 1, wherein said system uses a hierarchical structure for the shopping carts, or uses one or more carts within another cart.

12. A system as recited in claim 1, wherein said system uses one or more of the following for security: encryption, biometrics, smart card, password, or an authentication method.

13. A system as recited in claim 1, wherein said system uses one or more messages along with the requests or transaction of data or information.

14. A system as recited in claim 1, wherein said system uses one or more of the following for the authorization purposes: parent, guardian, legal entity, judge, employer, or supervisor.

15. A system as recited in claim 1, wherein said system uses predetermined formats for interface, data, or information.

16. A system as recited in claim 1, wherein said system uses one or more of the following for communication: cell phone, PDA, phone, mobile device, laptop, computer, I-Pod, pager, hybrid device, multi-functional device, or communication device.

17. A system for requesting or suggesting a proxy transaction, said system comprising:
an inventory; and
a communication means,
wherein a user accesses said inventory to select one or more items, objects, or services,
wherein said user suggests or requests to a second entity to pay for all or part of said selected one or more items, objects, or services, and
wherein if said second entity accepts said suggestion or request to pay, then said second entity pays for all or part of said selected one or more items, objects, or services.

18. A system as recited in claim 17, wherein said system uses an affiliate network or another website for the content of said inventory.

19. A system as recited in claim 17, wherein said system is used within another system or web site.

20. A system as recited in claim 19, wherein said another system or web site is PayPal, Amazon, or Visa.
